(19) United States
(12) Patent Application Publication
(10) Pub. No.: US 2020/0133223 A1
(43) Pub. Date: Apr. 30, 2020

(54) NC-based ring blade production apparatus

(71) Applicant: Mengxiao Ye, Ningbo City (CN)

(72) Inventor: Mengxiao Ye, Ningbo City (CN)

(21) Appl. No.: 16/726,827

(22) Filed: Dec. 25, 2019

(30) Foreign Application Priority Data
Sep. 6, 2019 (CN) 2019108426861

(51) Int. Cl. G05B 19/18; B23B 51/02

(52) U.S. Cl. CPC G05B 19/182; G05B 2219/36198; B23B 51/02

(57) ABSTRACT

The invention discloses a NC-based ring blade production apparatus, which includes a box body, which is provided with a processing cavity penetrating forward and backward, and the processing cavity is symmetrically provided with clamping devices. An annular blade can be clamped between them. The annular blade after processing has a cutting edge hole penetrating up and down, a transmission device is arranged in the upper inner wall of the processing cavity, and the lower end of the transmission device is screwed to the clamping device. The present invention controls the processing of the annular blade through the numerical control method of human-machine interaction, improves the accuracy of the annular blade, and can also perform the reaming process of the edge hole of the existing annular blade, thereby improving the recycling of the annular blade.

### CROSS-REFERENCES TO RELATED APPLICATIONS

The present application claims priority from Chinese application No. 2019108426861 filed on Sep. 6, 2019 which is hereby incorporated by reference in its entirety.

### FIELD OF TECHNOLOGY

The invention relates to the field of machinery processing and production, and in particular relates to a NC-based ring blade production apparatus.

### TECHNICAL FIELD

The blade generally refers to the sheet-like parts used for cutting on the machine. The blade of the general blade is facing outward. Sometimes when the blade is artificially taken, the hand is easy to be cut by the blade, while the edge of the circular blade is facing inward and artificially taken. The ring blade will not touch the blade when it is cut, avoiding the hand being cut by the blade. Now the application of the ring blade is not widespread, and the accuracy of the produced ring blade is low. A numerical control-based ring blade production device described in the present invention can solve the problem. In the above problem, the present invention controls the machining of the annular blade through the numerical control method of human-machine interaction, improves the accuracy of the annular blade, and can also perform the reaming process of the edge hole of the existing annular blade, thereby improving the recycling of the annular blade.

### CONTENT OF THE INVENTION

### Technical Problem

Ring blades are not widely used, and the accuracy of the produced ring blades is low.

In order to solve the above problem, a numerical control-based circular blade production device is designed in this example. A numerical control-based circular blade production device in this example includes a box body, and a processing cavity is provided through the box body. A clamping device is provided symmetrically in the processing cavity, and the annular blades can be clamped between the clamping devices. After processing, the annular blade has a vertical and vertical cutting edge hole, and an inner wall of the upper side of the processing cavity is provided. There is a transmission device, and the lower end of the transmission device is threadedly connected to the clamping device, and the clamping device can be driven to move up and down through the transmission device, and then the annular blade can be driven to move up and down. A processing device is provided in the processing cavity. The processing device is located between the clamping devices, the upper end of the processing device is connected to the transmission device, and the processing device can drive the processing device and process the annular blade through the transmission device, and the box body An operation panel is fixed in the left end surface, and the operation panel is electrically connected to the processing device. An operator can adjust the processing device to the ring through the operation panel. Machining accuracy of the blade, the lower inner wall of the process chamber in communication with the waste chamber, the waste chamber can collect the generated waste processing after the annular blade.

Advantageously, the transmission device comprises a transmission cavity provided in an inner wall on the upper side of the processing cavity, and a driving pulley is rotatably provided in the driving cavity, and a motor shaft is fixedly connected to the upper end of the driving pulley. A drive motor is fixed in the upper inner wall of the transmission cavity, and the upper end of the motor shaft is dynamically connected to the drive motor. A driven pulley and a large pulley are rotatably provided on the right side of the driving pulley. A pulley is located on the upper side of the large pulley. A fast belt is connected between the driving pulley and the driven pulley. A slow belt is connected between the driving pulley and the large pulley. A fast rotating shaft is fixedly connected to the driven pulley, a lower end of the fast rotating shaft extends into the processing cavity and is connected to the processing device, and a slow rotating shaft is fixedly connected to the lower end of the large pulley. The lower end extends into the processing chamber and is connected to the processing device. The fast rotating shaft can rotate between the large pulley and the slow rotating shaft to start the driving motor, which is then driven by the motor shaft. The active pulley rotates, and then passes through the rapid skin Drive the driven pulley to rotate, and then drive the processing device through the fast rotating shaft, and at the same time, the driving pulley drives the large pulley through the slow belt, and then drive the machine through the slow rotating shaft. Mentioned processing device.

Advantageously, there is an acceleration transmission between the driving pulley and the driven pulley, and a reduction transmission between the driving pulley and the large pulley.

Preferably, a small pulley is provided symmetrically and rotatably on the left and right sides of the large pulley. A transmission belt is connected between the small pulley and the large pulley, and a screw is fixedly connected to the small pulley. The lower end of the screw extends into the processing cavity and is screw-connected with the clamping device, the large pulley rotates and drives the small pulley through the transmission belt, and then the clamp drives the clamp Hold the device up and down.

Beneficially, the clamping device includes a slide bar provided in the processing cavity symmetrically and slidably, the slide bar is provided with a screw hole with an upward opening therein, and the lower end of the screw extends into the screw hole. It is screw-connected with the slide bar. A fixed block is fixedly connected to one end of the slide bar near the center of symmetry. A circular arc slot with an opening facing the center of symmetry is formed in the fixed block. A clamping plate is slidably provided. A clamping spring is fixedly connected between an end of the clamping plate far from the center of symmetry and the upper and lower inner walls of the arc groove. In the arc groove, the annular blade is clamped by the clamping plate under the elastic force of the clamping spring.

Beneficially, the processing device includes a rotating wheel rotatably disposed in the processing cavity, and a lower end of the slow rotating shaft is fixedly connected to the rotating wheel, and a gear cavity is provided in the rotating wheel, and the gear cavity An internally rotatable fixed gear is provided, and the lower end of the fast rotating shaft is fixedly connected to the fixed gear. The left end of the fixed gear is provided with an intermediate gear. The left end of the intermediate gear is provided with a sliding gear. A sliding shaft is fixedly connected to the sliding gear, and a limiting groove with an opening downward is communicated in the inner wall of the lower side of the gear cavity. The lower end of the sliding shaft passes through the limiting groove and extends outside the runner. The sliding shaft is provided with a downwardly-facing connection port, and a drill bit is connected to the connection port. The fast rotating shaft rotates and drives the fixed gear to rotate, thereby driving the intermediate gear to rotate, and further driving the sliding gear to rotate. Further, the drill bit is driven to rotate by the sliding shaft, so that the annular blade can be processed, and at the same time, the slow rotating shaft is rotated and the rotary wheel is rotated, so that the drill bit can be driven around the rotary wheel. A rotation center, since the rotational speed of the shaft is greater than the rotational speed of the fast shaft slow, and thus the drill bit rotation speed is greater than the rotational speed of said wheel about a center of rotation.

Preferably, a communication groove is provided in the inner wall of the upper side of the gear cavity, and a communication block is slidably provided in the communication groove. The upper end of the sliding shaft is rotatably connected to the connection block. A threaded rod is connected to the internal thread, and a numerically controlled motor is fixed in the left inner wall of the communication slot. The left end of the threaded rod is dynamically connected to the numerically controlled motor. The numerically controlled motor is electrically connected to the operation panel. The operation panel controls the numerically controlled motor to start, and further drives the connecting block to slide through the lead screw, thereby driving the sliding shaft and the drill bit to adjust the machining aperture of the blade hole.

Preferably, a fixed shaft is fixedly connected to the upper end of the intermediate gear, and a connecting rod is rotatably connected to the upper end of the fixed shaft. A spring groove is connected to the inner wall of the front side of the gear cavity, and the front end of the connecting rod extends to the A telescopic spring is connected in the spring groove and between the front wall of the spring groove, and the link is pushed by the elastic force of the telescopic spring, and then the intermediate gear is caused to slide through the fixed shaft, so that The intermediate gear is always in mesh with the fixed gear and the sliding gear.

Preferably, a guide groove with a downward opening is provided through the runner to the left and right, and a guide slider is slidably provided in the guide groove, and the slide shaft and the guide slider can rotate. The guide slider can prevent the sliding shaft from tilting, thereby tilting the drill bit.

The beneficial effect of the present invention is that the present invention controls the machining of the annular blade through the numerical control method of human-computer interaction, improves the accuracy of the annular blade, and can also perform the reaming process of the edge hole of the existing annular blade, thereby improving the recycling of the annular blade.

### BRIEF DESCRIPTION OF THE DRAWINGS

For ease of description, the present invention is described in detail by the following specific embodiments and the accompanying drawings.

FIG. 1 is a schematic diagram of the overall structure of a numerical control-based annular blade production device according to the present invention;

FIG. 2 is an enlarged schematic view of “A” of FIG. 1;

FIG. 3 is a schematic structural diagram in a direction “B-B” of FIG. 1;

FIG. 4 is an enlarged schematic view of “C” of FIG. 1;

FIG. 5 is a schematic structural diagram of a “D-D” direction of FIG. 2;

FIG. 6 is a schematic structural diagram of the “E-E” direction of FIG. 4;

FIG. 7 is a schematic structural view of a circular blade after processing.

### DETAILED DESCRIPTION OF THE INVENTION

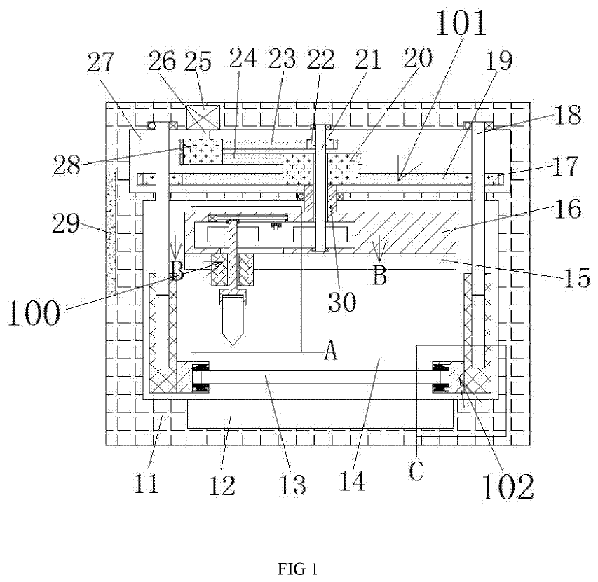

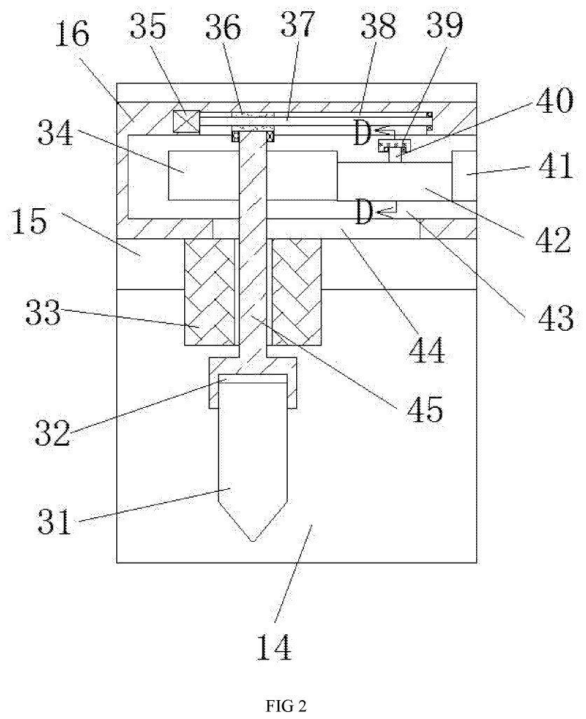

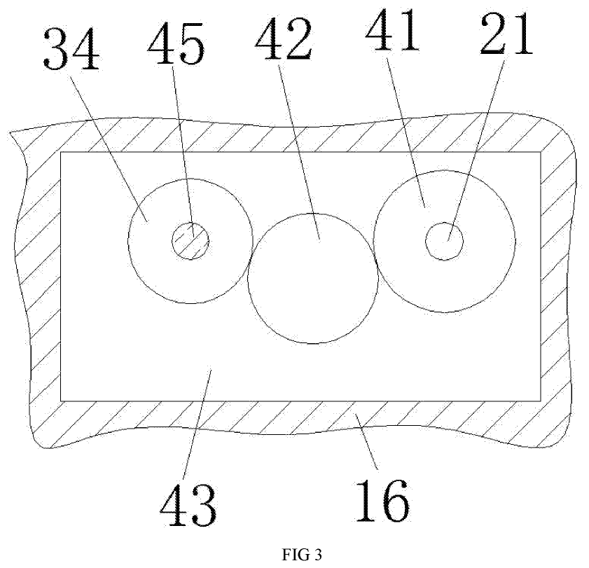

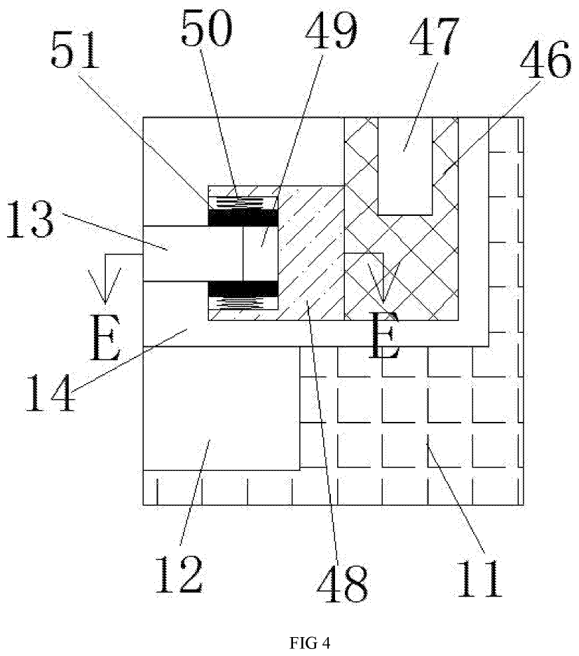

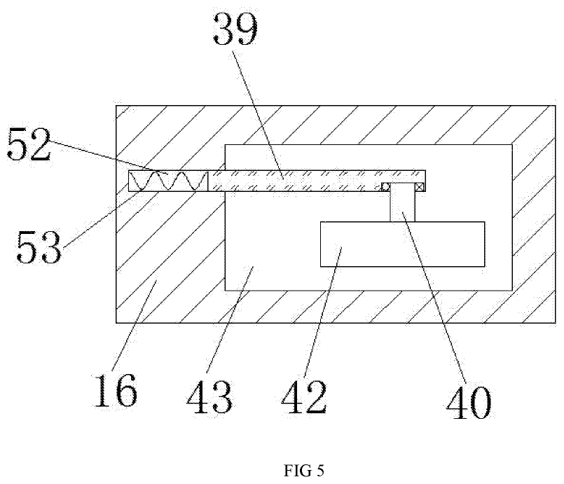

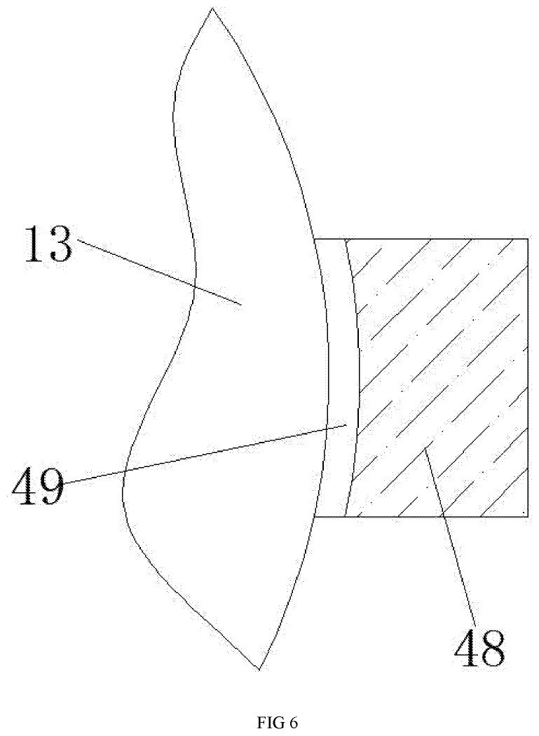

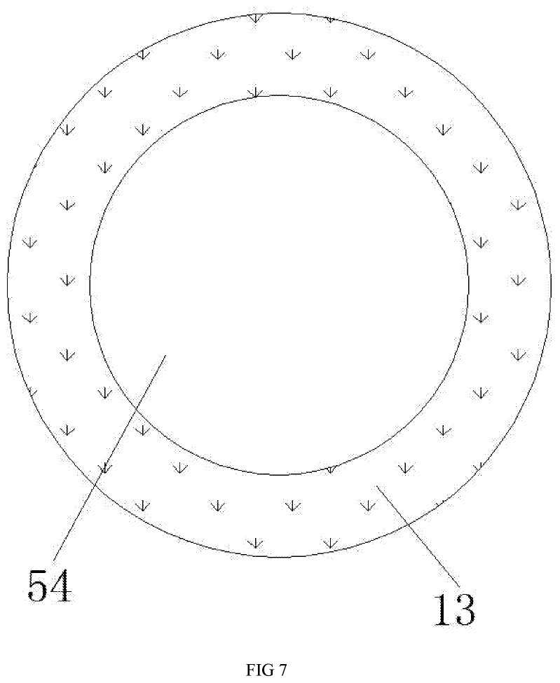

The present invention is described in detail below with reference to FIGS. 1 to 7. For convenience of description, the orientation described below is defined as follows: the up-down, left-right, front-back direction described below is consistent with the up-down, left-right, front-back direction of the projection relationship of FIG. 1 itself.

The invention relates to a numerical control-based annular blade production device, which is mainly used for high-precision production and processing of annular blades. The invention will be further described below with reference to the accompanying drawings of the invention:

The numerical control-based annular blade production device according to the present invention includes a box body 11, which is provided with a processing cavity 14 penetrating back and forth, and the processing cavity 14 is provided with clamping devices 102 symmetrically on the left and right sides. An annular blade 13 can be clamped between the clamping devices 102. After machining, the annular blade 13 has a cutting edge hole 54 penetrating up and down, and a transmission device 101 is provided in the upper inner wall of the processing cavity 14. The lower end of the transmission device 101 is screw-connected to the clamping device 102. The transmission device 101 can drive the clamping device 102 to move up and down, and then can drive the annular blade 13 to move up and down. The processing cavity 14 is provided with processing Device 100, the processing device 100 is located between the clamping devices 102, and the upper end of the processing device 100 is connected to the transmission device 101, and the processing device 100 can drive the processing device 100 and control the ring shape The blade 13 is used for processing. An operation panel 29 is fixed in the left end surface of the box 11, and the operation panel 29 is electrically connected to the processing device 100. An operator can adjust the processing device 100 through the operation panel 29. To the ring Machining accuracy of the blade 13, the lower side 14 of the inner wall of the processing chamber in communication with the waste chamber 12, a waste chamber 12 can collect scrap 13 after the annular insert processing.

According to the embodiment, the transmission device 101 is described in detail below. The transmission device 101 includes a transmission cavity 27 provided in the inner wall on the upper side of the processing cavity 14. An active belt is rotatably provided in the transmission cavity 27. A motor 28 is fixedly connected to the upper end of the driving pulley 28. A driving motor 25 is fixed in the upper inner wall of the transmission cavity 27. The upper end of the motor shaft 26 is dynamically connected to the driving motor 25. A driven pulley 22 and a large pulley 20 are rotatably provided on the right side of the driving pulley 28. The driven pulley 22 is located on the upper side of the large pulley 20. The driving pulley 28 and the driven pulley 28 A fast belt 23 is connected between the pulleys 22, a slow belt 24 is connected between the driving pulley 28 and the large pulley 20, and a fast rotating shaft 21 is fixedly connected to the driven pulley 22. The lower end of the fast rotating shaft 21 extends into the processing cavity 14 and is connected to the processing device 100. A slow rotating shaft 30 is fixedly connected to the lower end of the large pulley 20, and the lower end of the slow rotating shaft 30 extends to the processing cavity 14. Inside and connected to the processing device 100, between the fast rotating shaft 21 and the large pulley 20 and the slow rotating shaft 30 Rotate, start the drive motor 25, and then drive the driving pulley 28 through the motor shaft 26, and then drive the driven pulley 22 through the fast belt 23, and then through the fast rotating shaft 21 The processing device 100 is driven, and at the same time, the active pulley 28 drives the large pulley 20 to rotate through the slow belt 24, and then drives the processing device 100 through the slow rotating shaft 30.

Beneficially, there is an acceleration transmission between the driving pulley 28 and the driven pulley 22, and a reduction transmission between the driving pulley 28 and the large pulley 20.

Advantageously, a small pulley 17 is provided symmetrically and rotatably on the left and right sides of the large pulley 20, and a transmission belt 19 is connected between the small pulley 17 and the large pulley 20, and the small pulley 17 A screw 18 is fixedly connected inside. The lower end of the screw 18 extends into the processing cavity 14 and is screwed with the clamping device 102. The large pulley 20 rotates and drives the small pulley through the transmission belt 19. 17 rotates, and then the clamping device 102 is driven by the screw 18 to rise and fall.

According to an embodiment, the clamping device 102 is described in detail below. The clamping device 102 includes a slide bar 46 symmetrically and slidably disposed in the processing cavity 14. The slide bar 46 is provided with the slide bar 46. A screw hole 47 with an upward opening is formed. The lower end of the screw 18 extends into the screw hole 47 and is threadedly connected to the sliding rod 46. A fixed block 48 is fixed to one end of the sliding rod 46 near the center of symmetry. A circular arc slot 49 penetrating back and forth in 48 is provided with an opening facing the center of symmetry, and a clamping plate 51 is symmetrically and slidably arranged in the circular arc slot 49, and one end of the clamping plate 51 away from the center of symmetry is connected with the A clamping spring 50 is fixedly connected between the upper and lower inner walls of the circular arc groove 49. The left and right ends of the annular blade 13 extend into the circular arc groove 49 on both sides, and pass through the spring under the elastic force of the clamping spring 50. The clamping plate 51 clamps the annular blade 13.

According to an embodiment, the processing device 100 will be described in detail below. The processing device 100 includes a rotating wheel 16 rotatably disposed in the processing cavity 14, and a lower end of the slow rotating shaft 30 is fixed to the rotating portion. The wheel 16 is provided with a gear cavity 43 therein. The gear cavity 43 is rotatably provided with a fixed gear 41. The lower end of the fast rotating shaft 21 is fixedly connected to the fixed gear 41. The fixed gear 41 An intermediate gear 42 is meshed at the left end, and a sliding gear 34 is meshed at the left end of the intermediate gear 42. A sliding shaft 45 is fixedly connected to the sliding gear 34. The inner wall of the lower side of the gear cavity 43 communicates with each other. A restriction slot 44 with an opening downward is provided. The lower end of the sliding shaft 45 passes through the restriction slot 44 and extends outside the runner 16. The sliding shaft 45 is provided with a connection opening 32 having an downward opening therein. A drill bit 31 is connected to the connection port 32. The fast rotating shaft 21 rotates and drives the fixed gear 41 to rotate, thereby driving the intermediate gear 42 to rotate, and further drives the sliding gear 34 to rotate, and further passes the sliding shaft 45. Drive the drill 31 to rotate, so that the ring The sheet 13 is processed, and at the same time, the slow rotating shaft 30 rotates and drives the rotating wheel 16 to rotate, so that the drill bit 31 can be rotated around the rotating center of the rotating wheel 16. The rotation speed of the slow rotating shaft 30 and the rotation speed of the drill 31 are greater than the rotation speed of the drill 31 around the rotation center of the wheel 16.

Beneficially, a communication groove 38 is provided in the inner wall of the upper side of the gear cavity 43 to communicate with each other. A connection block 36 is slidably provided in the communication groove 38. The upper end of the sliding shaft 45 is rotatably connected to the connection block 36. The connecting block 36 is internally screwed with a screw rod 37, and a numerically controlled motor 35 is fixed in the left inner wall of the communication groove 38. The left end of the screw rod 37 is dynamically connected to the numerically controlled motor 35. The numerically controlled motor 35 It is electrically connected to the operation panel 29. The operator controls and starts the NC motor 35 through the operation panel 29, and further drives the connecting block 36 to slide through the screw rod 37, thereby driving the slide shaft 45 and the The drill 31 slides to adjust the machining diameter of the cutting edge hole 54.

Beneficially, a fixed shaft 40 is fixedly connected to the upper end of the intermediate gear 42, and a connecting rod 39 is rotatably connected to the upper end of the fixed shaft 40. A spring groove 52 is provided in the inner wall of the front side of the gear cavity 43. The front end of the rod 39 extends into the spring groove 52 and is connected to a front inner wall of the spring groove 52 with a telescopic spring 53. The elastic force of the telescopic spring 53 pushes the link 39 and further passes through the link 39. The fixed shaft 40 drives the intermediate gear 42 to slide, so that the intermediate gear 42 and the fixed gear 41 and the sliding gear 34 are always kept in mesh.

Beneficially, a guide groove 15 with a downward opening is provided in the runner 16 to the left and right, and a guide slider 33 is slidably provided in the guide groove 15. The slide shaft 45 and the guide slider 33 are provided. It is rotatable between them, and the slide shaft 45 can be prevented from being inclined by the guide slider 33, and the drill 31 can be inclined.

The following describes in detail the use steps of a numerical control-based ring blade production device in this article with reference to FIGS. 1 to 7:

Initially, the slide bar 46 and the fixed block 48 are located at the lower limit position. At this time, the sliding gear 34 and the fixed gear 41 are close to each other. At this time, the telescopic spring 53 is in a compressed state.

During use, the annular blade 13 is sandwiched between the clamping plates 51 and the annular blade 13 is clamped by the elastic force of the clamping spring 50. At this time, the operator controls and starts the numerical control motor 35 through the operation panel 29, and is then driven by the screw rod 37 The connecting block 36 slides, which in turn drives the slide shaft 45 and the drill 31 to slide. The guide slider 33 guides the slide of the slide shaft 45 to prevent the slide shaft 45 and the drill 31 from tilting. Between the drill 31 and the rotation center of the wheel 16 When the distance equal to the radius of the blade hole 54 to be processed by the annular blade 13 is stopped, the numerical control motor 35 is stopped, and the sliding shaft 45 slides while driving the sliding gear 34 to slide. At this time, the link 39 is pushed by the elastic force of the expansion spring 53 to slide, and The fixed gear 40 drives the intermediate gear 42 to slide, so that the intermediate gear 42 and the fixed gear 41 and the sliding gear 34 always keep meshing. At this time, the driving motor 25 is started, and then the driving pulley 28 is driven to rotate by the motor shaft 26, and then the slow belt is passed. 24 drives the large pulley 20 to rotate, and then rotates the rotary wheel 16 through the slow rotating shaft 30, so that the drill 31 rotates around the rotation center of the rotary wheel 16, while the large pulley 20 passes The transmission belt 19 drives the small pulley 17 to rotate, and then drives the slide bar 46 to rise through the screw 18, which in turn drives the fixed block 48 to rise, and then drives the annular blade 13 to rise and contact the drill 31. At the same time, the active pulley 28 drives the driven through the fast belt 23 The pulley 22 rotates, and then the fixed gear 41 rotates through the fast rotating shaft 21, and the intermediate gear 42 rotates, and the slide gear 34 rotates, and the drill 31 rotates through the slide shaft 45, and the ring blade 13 is processed.

After the drill 31 penetrates the annular blade 13 and processes the cutting edge hole 54, the waste material is dropped into the waste cavity 12 and collected. After the processing is completed, the annular blade 13 is taken out and the device is restored to the initial state.

The beneficial effect of the present invention is that the present invention controls the machining of the annular blade through the numerical control method of human-computer interaction, improves the accuracy of the annular blade, and can also perform the reaming process of the edge hole of the existing annular blade, thereby improving the recycling of the annular blade.

In the above manner, those skilled in the art can make various changes according to the working mode within the scope of the present invention.

1. A numerical control-based annular blade production device, including a box body;
There are processing chambers penetrating back and forth in the box body, and clamping devices are symmetrically arranged in the processing chamber. The clamping devices can clamp ring blades between them. A perforated blade hole;
A transmission device is arranged in the upper inner wall of the processing cavity, and the lower end of the transmission device is screwed to the clamping device, and the clamping device can be driven to move up and down through the transmission device, and then the annular blade can be driven up and down;
A processing device is disposed in the processing chamber, the processing device is located between the clamping devices, and an upper end of the processing device is connected to the transmission device, and the processing device can drive the processing device and control the processing device. Circular blade for processing;
An operation panel is fixedly installed in the left end surface of the box, and the operation panel is electrically connected to the processing device. An operator can adjust the processing accuracy of the annular blade by the processing device through the operation panel. A waste cavity is connected to the inner wall of the lower side of the processing cavity, and the waste cavity can collect waste generated after the annular blade is processed.

2. The device for producing a circular blade based on numerical control according to claim 1, wherein the transmission device comprises a transmission cavity provided in an inner wall on the upper side of the processing cavity, and the transmission cavity is rotatably provided with A driving pulley, a motor shaft is fixedly connected to the upper end of the driving pulley, and a driving motor is fixed in the upper inner wall of the transmission cavity; the upper end of the motor shaft is dynamically connected to the driving motor;
A driven pulley and a large pulley are rotatably provided on the right side of the driving pulley, the driven pulley is located on the upper side of the large pulley, and between the driving pulley and the driven pulley A fast belt is connected, and a slow belt is connected between the active pulley and the large pulley;
A fast rotating shaft is fixedly connected to the driven pulley, a lower end of the fast rotating shaft extends into the processing cavity and is connected to the processing device, and a slow rotating shaft is fixedly connected to the lower end of the large pulley. The lower end of the rotating shaft extends into the processing cavity and is connected to the processing device. The fast rotating shaft can rotate between the large pulley and the slow rotating shaft.

3. The device for producing annular blades based on numerical control according to claim 2, characterized in that: the driving pulley and the driven pulley are accelerated transmission, and the driving pulley and the large pulley Reduced transmission between.

4. The device for producing a circular blade based on numerical control according to claim 3, wherein the large pulley is provided with small pulleys symmetrically and rotatably on the left and right sides, and the small pulley and the large belt A transmission belt is connected between the wheels, and a screw is fixedly connected to the small belt wheel. The lower end of the screw extends into the processing cavity and is screw-connected with the clamping device.

5. The device for producing a circular blade based on numerical control according to claim 4, characterized in that the clamping device includes a slide bar provided in the processing cavity symmetrically and slidably, and the slide bar is provided in the slide bar. There is a threaded hole with an upward opening, and the lower end of the screw extends into the threaded hole and is threadedly connected with the sliding rod;
A fixed block is fixedly connected to one end of the slide bar near the center of symmetry, and a circular arc slot with an opening facing the center of symmetry is formed in the fixed block, and a clamping plate is symmetrically and slidably arranged in the circular arc slot. A clamping spring is fixedly connected between one end of the clamping plate far from the center of symmetry and the upper and lower inner walls of the arc groove.

6. The device for producing a circular blade based on numerical control according to claim 2, characterized in that the processing device comprises a rotary wheel which is rotatable in the processing cavity, and the lower end of the slow rotating shaft is fixedly connected to the rotary shaft. Narrative runner
A gear cavity is provided in the runner, a fixed gear is rotatably provided in the gear cavity, a lower end of the fast rotating shaft is fixedly connected to the fixed gear, and an intermediate gear is provided at the left end of the fixed gear. A sliding gear is engaged at the left end of the intermediate gear, a sliding shaft is fixedly connected to the sliding gear, and a downward-limiting opening groove is communicated in the inner wall of the lower side of the gear cavity. The lower end of the sliding shaft passes through The restriction groove extends to the outside of the runner, and a connection opening with a downward opening is provided in the sliding shaft, and a drill bit is connected in the connection opening.

7. The annular blade production device based on numerical control according to claim 6, characterized in that: a communication groove is provided in the inner wall of the upper side of the gear cavity to communicate with each other, and a connection block is slidably provided in the communication groove, The upper end of the sliding shaft is rotatably connected to the connection block. A screw rod is internally connected to the connection block. A numerical control motor is fixed in the left inner wall of the communication groove. The numerically controlled motor is electrically connected to the operation panel.

8. The numerical control-based annular blade production device according to claim 6, characterized in that: a fixed shaft is fixedly connected to the upper end of the intermediate gear, a connecting rod is rotatably connected to the upper end of the fixed shaft, and the inner wall of the front side of the gear cavity A spring slot is provided in the interior, and a front end of the link extends into the spring slot and a telescopic spring is connected to the front wall of the spring slot.

9. The device for producing a circular blade based on numerical control according to claim 6, characterized in that the left and right through the runner are provided with guide grooves with downward openings, and the guide groove is slidably provided with a guide slide Block, rotatable between the sliding shaft and the guide slider.
